(19) United States
(12) Patent Application Publication
(10) Pub. No.: US 2025/0141289 A1
(43) Pub. Date: May 1, 2025

(54) TEMPERING PUMP WITH A STRUCTURED ROTOR CORE

(71) Applicant: Tl Automotive Technology Center GmbH, Rastatt (DE)

(72) Inventor: Ivan KOM, Soufflenheim (FR)

(21) Appl. No.: 18/926,812

(22) Filed: Oct. 25, 2024

(30) Foreign Application Priority Data
Oct. 26, 2023 (DE) 102023129592.6

(51) Int. Cl. H02K 1/278; B60L 58/26; F04D 13/06; H01M 10/625; H01M 10/656; H02K 1/28

(52) U.S. Cl. CPC H02K 1/278; B60L 58/26; F04D 13/06; H02K 1/28; H01M 10/625; H01M 10/656

(57) ABSTRACT

A pump comprises a stator and a rotor, wherein the rotor has a rotor body and a rotor block, and is rotatably mounted around an axis of rotation. The rotor block has a metallic rotor core and magnets. The rotor core has several holes in a cross section. The rotor core comprises several grooves and several projections in a cross section on its radial inner wall.

### RELATED APPLICATIONS

The present disclosure claims priority to and the benefit of German Application 102023129592.6, filed on Oct. 26, 2023, the entire contents of each of which are incorporated herein by reference.

### FIELD

The disclosure relates to a pump for driving a fluid, preferably a tempering agent, in particular for use in a vehicle, including for use in tempering a drive battery of an electric vehicle. The pump comprises a stator and a rotor, wherein the rotor has a rotor body and a rotor block, and is rotatably mounted around an axis of rotation, wherein the rotor block comprises a metallic rotor core and magnets, wherein the rotor core comprises several holes in a cross section.

### BACKGROUND

EP 3 121 937 B1 discloses an electric pump for cooling vehicles with an internal combustion engine. The pump comprises a stator and a rotor, wherein the rotor on its part comprises a rotor body, two pivot bearings and a rotor block. The rotor block has a rotor core consisting of stacked electrical sheets and magnets, which are fastened to a radially exterior side of the rotor core. The electrical sheets have a plurality of holes, which serve to reduce the weight of the rotor core or block or the rotor on the one hand, and guide the magnetic field lines in the rotor core on the other.

The energy and mobility revolution requires the expansion of new technologies, which include in particular electric vehicles with a drive battery and an electric motor. Drive batteries achieve peak efficiency at temperatures of around 20° C., so that they must be heated or cooled depending on the situation. Heating makes sense in particular after startup in winter, while cooling is considered above all after the vehicle has already been driven for a while. In this regard, the thermal management of the drivetrain in electric vehicles differs from internal combustion vehicles above all in the cold season. Finally, the entire component chain (pipes, quick connectors, pumps, battery housing, etc.) of thermal management in electric vehicles must be configured to additionally operate in the cold season as well, and thus without the support of the airstream.

This means that a relatively high throughput of tempering fluid in the electric vehicle is required over the course of a year. As a consequence, the pump must be correspondingly efficient in design.

### BRIEF SUMMARY

The present disclosure provides embodiments of pumps for thermal management that are more efficient. The present disclosure increases efficiency without increasing production cost or material usage.

A pump for driving a fluid, preferably a tempering agent, in particular for use in a vehicle such as for use in tempering a drive battery of an electric vehicle, comprises a stator and a rotor, wherein the rotor has a rotor body and a rotor block, and is rotatably mounted around an axis of rotation, wherein the rotor block comprises a metallic rotor core and magnets, wherein the rotor core comprises several holes in a cross section, wherein the rotor core has several grooves and several projections in a cross section on its radial inner wall.

We have discovered that the rotor and in particular the rotor core can be further improved to increase the efficiency of the pump. It was found that the magnetic field lines tend to leave the provided, radially outer areas of the rotor core in some circumferential positions of the rotor relative to the stator. The magnetic field lines inside of the rotor core can then partially also extend between a radial interior side of the holes and a radial interior side of the rotor core. The scattering of magnetic field lines increases the magnetic resistance and decreases the engine efficiency. The stray fluxes are pronounced in particular in electric pumps, since the distance between the stator and the rotor block is relatively large due to the partition wall, the block housing and the annular gap provided for the secondary current, which amplifies the stray fluxes.

In particular, we have discovered that avoiding or reducing these stray fluxes raises the efficiency or effectiveness of the pump. It was found that the grooves on a radial interior side of the rotor core reduce the stray fluxes between the holes and the radial interior side of the rotor core. This concentrates the magnetic field lines more strongly on the radially outer area of the rotor core, which increases the efficiency or effectiveness of the pump.

It is preferred that the axis of rotation A define an axial, a radial and/or a tangential or rotational direction. The expression “radially inside” refers to the radial direction toward the axis of rotation A. The term “axially inward” refers to the axial direction corresponding to the direction of the fluid that flows in the inlet. In particular, “axially inward” refers to an axial direction from the pump impeller in the direction of the rotor block. The axially outermost section of the pump is preferably simultaneously the uppermost section of the pump. The end of the pump axially opposite the uppermost section is the lowermost section or the lower end. In a top view, the tangential directions can run either clockwise or counterclockwise. The rotor preferably turns clockwise.

The magnets are preferably permanent magnets. The rotor or the rotor block comprises at least six or eight magnets in a cross section. The rotor or rotor block advantageously comprises at most 20 or 16 or 14 magnets in cross section. The rotor core is advantageously at least sectionally arc-shaped along its circumference. The radial exterior side of the rotor core preferably has magnetic spaces for arranging a respective one magnet per magnetic space. It is very preferred that the magnets be arc-shaped in design on their radial interior side and/or on their radial exterior side as viewed from above or in cross section. It is advantageous that the magnetic spaces have an arc-shaped contour, and in particular a surface complementary to the magnets, as viewed from above or in cross section.

It is preferred that the rotor core have a plurality of lamellae stacked on top of each other, in particular rotor sheets. The rotor sheets are preferably electrical sheets. It is very preferred that the rotor core comprise at least 10 or 15 or 20 lamellae or rotor sheets. It is advantageous that the rotor core have at most 50 or 40 or 30 rotor sheets. A plurality of lamellae or rotor sheets expediently aligns over a complete rotation. The lamellae/rotor sheets can be connected with each other to the rotor core by means of stamped packaging or by means of baking varnish. It is advantageous that the rotor sheets be provided with an insulating coating.

According to a preferred embodiment, the pump is designed in such a way that the fluid flushes the block housing of the rotor body during pump operation. As a result, a secondary flow from the impeller chamber or a impeller chamber can flow into the/a drive chamber. The secondary flow of fluid can then flow via return channels or a return channel back into the impeller chamber through the rotor in an axially outward direction. In this way, the secondary flow takes along the heat from the stator, the rotor and/or a circuit board, allowing the pump to be cooled and operated more efficiently overall.

According to a preferred embodiment, the rotor body or the block housing has a plastic. The rotor body or the block housing is advantageously one-piece and preferably integral in design. If the rotor body is manufactured integrally and, for example, via injection molding or overmolding, the rotor body has a lightweight, and yet very stable structure. This makes it possible to realize very many details on the rotor body, among which in particular return channels and blades are of note. As a result, the rotor body can be cheaply manufactured, even though it comprises a great many technical details. At the same time, the rotor body with an integral structural design is characterized by a correspondingly great robustness, so that it can be built with relatively thin walls. This analogously also applies to the block housing.

The rotor expediently comprises a pump impeller and/or a shaft. The pump impeller advantageously has a impeller disk and/or blades and/or a impeller cover. The impeller disk is expediently arranged axially inwardly in relation to the blades. In a top view, the blades preferably define blade channels between them. It is possible that the blades be covered in an axially outward direction by a impeller cover. In particular, the impeller cover can be fastened to the blades via plugging or welding.

It is preferred that the rotor body comprise the blades and/or the impeller disks and/or the shaft. The shaft advantageously has a drive section and/or a connecting section. The drive section and the block housing expediently overlap in an axial direction. According to a preferred embodiment, the block housing, the drive section, the connecting section of the impeller disks and/or the blades are integrally connected with each other, and preferably form the rotor body.

According to a preferred embodiment, the grooves alternate with the projections in a tangential direction. It is possible that the tangential expansion of the grooves corresponds to that of the projections. It is preferred that the inner wall of the rotor core consist exclusively of the grooves and projections. As a result, the largest possible areas of the radial inner wall help to guide the field lines. The grooves and projections preferably extend along at least 50 or 60 or 70 or 80 or 90 or 100% of the axial expansion of the rotor core or rotor block. The upper cover lamella, the lower cover lamella, the holder lamellae and/or the block lamellae advantageously have the grooves and the projections. As a result, the largest possible areas of the radial inner wall help to guide the field lines.

It is preferred that the holes be offset in a tangential direction to the grooves. The holes and the grooves preferably alternate in a tangential direction. It is very especially preferred that the holes and the grooves do not overlap in a tangential direction. Free spaces advantageously are located between the magnets in a cross section of the rotor block in the tangential direction. A groove is preferably allocated to at least one of the free spaces in a tangential direction. At least one of the free spaces advantageously overlaps with the allocated groove in a tangential direction. The at least one free space and its allocated groove are especially preferably axially symmetrical in design relative to a shared radius line. This makes it possible to guide or spatially delimit the field lines radially inward, which keeps the magnetic field compact and the magnetic resistance low.

According to a preferred embodiment, the number of magnets in a cross section of the rotor core corresponds to the number of holes, grooves and/or projections. This causes the magnetic field lines to be influenced in a targeted manner in relation to each magnet. If a hole is allocated to each magnet, each magnet can be supported in the same way as the field lines are being guided through the hole. As a result, practically the same drive of the rotor is achieved by each magnet, so that the quietest possible running is achieved.

In a cross section of the rotor core, one of the holes and/or one of the projections is preferably allocated to at least one of the magnets, preferably each of the magnets, of the rotor block, in particular in a tangential direction. The at least one magnet advantageously overlaps in a tangential direction with the allocated hole and/or with the allocated projection. The at least one magnet and/or the hole allocated to the magnet and/or the projection allocated to the magnets are axially symmetrical in design relative to a common radius line. Because of the axial symmetry, the magnetic fields are always as similar in design as possible while wandering through the rotor block or core, so that a very quiet running can be achieved.

It is advantageous that at least one of the holes and a projection allocated to the at least one hole in a tangential direction overlap in a tangential direction. It is preferred that all of the holes overlap in a tangential direction with the respectively allocated projection in a tangential direction. The at least one hole and the projection allocated to the hole are preferably axially symmetrical in design relative to a common radius line. It is preferred that a tangential expansion of the projection correspond to at least 50 or 60 or 70 or 80 or 90% of the tangential expansion of the hole. A radial expansion of a groove RN advantageously corresponds to a radial expansion of a projection. It is preferred that a cross sectional area of the projection formed by the radial expansion of the projection and the tangential expansion of the projection correspond to at least 50 or 60 or 70 or 80 or 90% of the cross sectional area of the allocated hole. This yields a relatively uniform distribution of the rotor core material over a rotation, as a result of which electromagnetic or mechanical irregularities are diminished and running smoothness is increased.

In a cross section of the rotor core, two of the magnets and preferably all magnets of the rotor block ideally have the same shape and/or the same magnetic properties and/or the same radial position. It is preferred that two of the holes and preferably all of the holes of the rotor core have the same shape and/or the same radial position. It is preferred that two of the projections and preferably all of the projections of the inner wall of the rotor core have the same shape and/or the same radial position. It is preferred that two of the grooves and preferably all of the grooves of the inner wall of the rotor core have the same shape and/or the same radial position. This enables a uniform or repeating configuration of the rotor block in a tangential direction, as a result of which a very smooth running is achieved.

It is preferred that a radial expansion RL of the holes and a radial expansion RKV of the rotor core have an RL/RKV ratio of at most 0.80 or 0.70 or 0.60 or 0.55 or 0.50 at a circumferential position of a projection. As a result, the holes are relatively flat in design in relation to the radial expansion of the rotor core. This makes it possible to give somewhat more space to the field lines in a radially outer area of the rotor core, so that the field lines can be well delimited in a radially outer area. It is preferred that an outer radius AR of the rotor core and a radial expansion RKN of the rotor core have an AR/RKN ratio of at least 2.0 or 2.3 or 2.5 or 2.7 or 3.0 or 3.2 at a circumferential position of a groove. This keeps the rotor core relatively thin or slender in a radial direction in relation to the outer radius AR or diameter of the rotor core. In particular, the smaller the RL/RKV ratio, the larger the AR/RKN ratio can be here.

According to a preferred embodiment, at least one of the grooves and/or at least one of the projections has a polygonal and preferably quadrangular shape. All grooves and/or all projections advantageously have a polygonal and preferably quadrangular shape. This tangentially relatively uniform shape evens out the radially acting effects of the grooves or projections in a tangential direction. It is preferred that a tangential expansion of the at least one groove be larger than the radial expansion of the groove by a factor of at least 1.5 or 2.0 or 2.5. It is preferred that a tangential expansion of the at least one projection be larger than the radial expansion of the projection by a factor of at least 1.5 or 2.0 or 2.5. As a result, the groove and/or the projection are oblong in design in a tangential direction. This enables a respective tangentially adequately pronounced effect relative to the radial effects of the projections or grooves.

According to a preferred embodiment, at least one of the holes and preferably all holes of the rotor core have a polygonal and in particular pentagonal shape in a cross section of the rotor core. It is advantageous that the at least one hole comprise a tip, which preferably faces radially outward. The tip is used above all to clearly separate the magnetic fields, and hence to avoid stray fluxes. The at least one hole advantageously comprises a radial exterior side. The tip of the hole advantageously represents the radially outermost point of the radial exterior side of the hole. It is preferred that the at least one hole comprise two tangential exterior sides. The at least one hole advantageously comprises a radial interior side. The radial interior side of the hole expediently connects the two tangential exterior sides of the hole.

According to a preferred embodiment, at least one of the holes and preferably all holes of the rotor core are filled with air. It is very especially preferred that the rotor core have an upper and/or a lower cover lamella. The upper and/or lower cover lamella has/have advantageously no hole. The upper and/or lower cover lamella is/are advantageously designed in such a way that no plastic flows into the holes of the rotor core during an overmolding process. This leads to an improved guiding of the field lines. It is advantageous that the holes extend over at least 50 or 60 or 70 or 80 or 90% of the axial expansion of the rotor core or rotor block.

It is advantageous that at least one of the grooves have a radial expansion RN, wherein the RN/RKN ratio preferably amounts to at least 0.1 or 0.14 or 0.17. As a result, the magnetic field lines are sufficiently limited. It is advantageous that the RN/RKN ratio measure at most 0.60 or 0.50 or 0.40 or 0.30 or 0.25. This makes it possible for the field lines to not be limited or deformed too strongly, so that the magnetic resistance is not increased.

### BRIEF DESCRIPTION OF THE DRAWINGS

The disclosure will be described with four figures below based on an exemplary embodiment. Schematically shown on:

FIG. 1 is a longitudinal section through a pump according to the disclosure, and

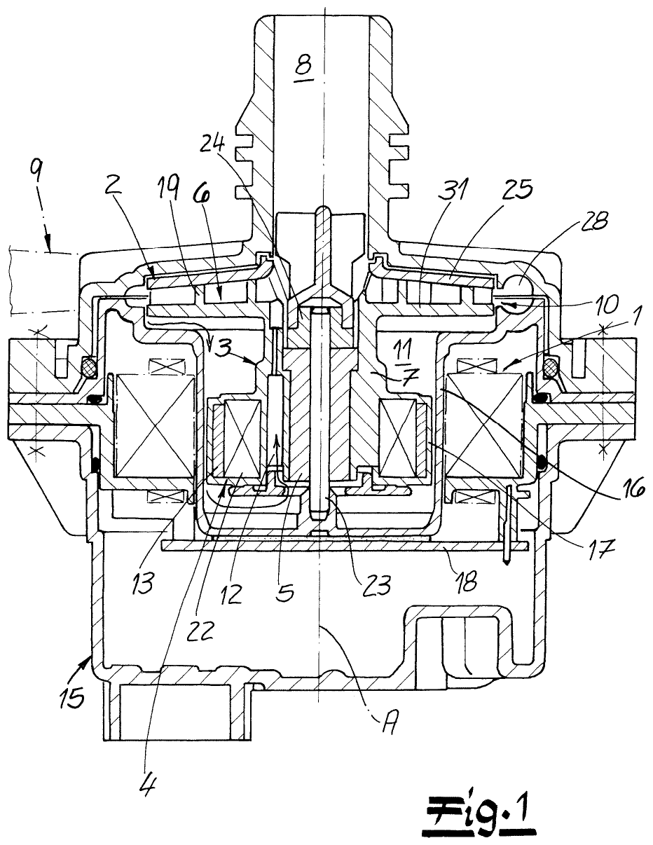

FIG. 2 is a perspective view of a simplified rotor block of the pump from FIG. 1,

FIG. 3 is a cross section through a simplified rotor block from FIGS. 1 and 2, and

FIG. 4 is a partial view of the rotor block from FIG. 3, but additionally with a simplified stator.

### DETAILED DESCRIPTION

A pump according to the disclosure expediently comprises an inlet 8 as well as an outlet 9, which is shown dashed due to the selected longitudinal section. The pump has a rotor 2, which expediently comprises a pump impeller 6. The pump has a stator 1, which drives the rotor block 4. The rotor block 4 is a part of the rotor 2. The rotor 2 expediently comprises a shaft 7, which transfers the torque of the rotor block 4 to the pump impeller 6. The pump impeller 6 preferably comprises blades 19 and/or a impeller disk 31.

The blades 19 fling the fluid flowing in via the inlet 8 radially outward, which is expediently collected by a collecting duct 28 along a nearly complete circumference. The collecting duct 28 expediently empties into the outlet 9. In this exemplary embodiment, the flow of fluid from the inlet 8 via the pump impeller 6 in the collecting duct 28 up to the outlet 9 is the primary flow of the fluid. The chain of elements 8, 6, 28, 9 here forms a primary flow path.

The pump preferably comprises a partition wall 16 and a housing 15. It is very preferred that the partition wall 16 separate a space inside of the housing 15 into a dry area and into a wet area. The stator 1 is preferably arranged in the dry area. It is advantageous that the pump comprise a circuit board 18 for controlling pump operation, and in particular for controlling the stator 1. It is preferred that the circuit board 18 be located in the dry area of the pump.

The wet area of the pump preferably comprises the inlet 8 and the outlet 9. It is preferred that the wet area have a impeller chamber 10, inside of which the pump impeller 6 is arranged. A drive chamber 11 expediently adjoins the impeller chamber 10 in an axially inward direction or in a longitudinal section toward the bottom, and advantageously is formed by the partition wall 16. It is very preferred that the rotor block 4 be arranged inside of the drive chamber 11.

A circumferential gap is advantageously located between the partition wall 16 and the impeller disk 31 or the pump impeller 6, through which the fluid can flow from the impeller chamber 10 into the drive chamber 11. It is very preferred that the rotor 2 have at least one return channel 12 and preferably several return channels 12, which extend(s) in a roughly axial direction inside of the rotor 2, and connect(s) a lowermost area of the drive chamber 11 with the impeller chamber 10.

Due to the pressure difference between the radially interior and radially exterior generated by the pump impeller 6, a small portion of the fluid—the secondary flow—flows from the impeller chamber 10 into the drive chamber 11, and from there past the rotor block 4 until into the lowermost area of the drive chamber 11. The secondary flow then enters into a lower entrance of the return channel 12 or the return channels 12, flows through the rotor 2 and finally exits above in a radially inner area of the impeller chamber 10. The secondary flow there mixes with the primary flow.

The advantage to the secondary flow is that the heat of the stator 1, the rotor block 4 and the circuit board 18 is dissipated, so that the pump as a whole can operate more efficiently. However, this simultaneously also means that the rotor block 4 is arranged inside of a wet area, and corresponding technical requirements must be placed on the rotor block 4 or on the rotor 2.

The rotor 2 in this exemplary embodiment comprises a rotor body 3, which preferably has a plastic. The rotor body 3 can have the blades 19, the impeller disk 31, the shaft 7, the return channels 12 and/or a block housing 17. In this exemplary embodiment, the rotor body 3 was manufactured in an injection molding or overmolding of the rotor block 4. The block housing 17 in this exemplary embodiment completely encloses the rotor block 4 with the magnets 13 and the rotor core 22. This ensures a very good protection of the rotor block 4 against the secondary flow. At the same time, overmolding makes it possible to generate very smooth outer surfaces of the rotor 2 or the rotor body 3, so that the rotor 2 turning in the fluid has good fluid dynamic properties.

In this exemplary embodiment, an axle 23 is fixedly mounted in a floor of the partition wall 16. The axle 23 defines an axis of rotation A, around which the rotor 2 turns. The rotor 2 can advantageously have a pivot bearing 5, which can be tribologically optimized and may in particular have graphite. The pump preferably comprises an axle holder 24, which in this exemplary embodiment is pressed into a receptacle of a spider [Spinne]. As a consequence, an upper, axial end face of the pivot bearing 5 turns relative to a lower, axial end face of the axle holder 24. It is very preferred that the rotor body 3 be generated by overmolding the pivot bearing 5 and the rotor block 4. The rotor 2 can have a rotor cover 25, which preferably is plugged onto the blades 19. A rotor cap can be arranged at a lower end of the motor 2, and preferably only fastened to the rotor 2 after overmolding.

In this exemplary embodiment, the block housing 17 is integrally connected with the shaft 7 of the rotor 2 or the rotor body 3, and preferably integrally connected with the impeller disk 31 and/or the blades 19 of the pump impeller. This integral connection is preferably achieved by overmolding the rotor block 4.

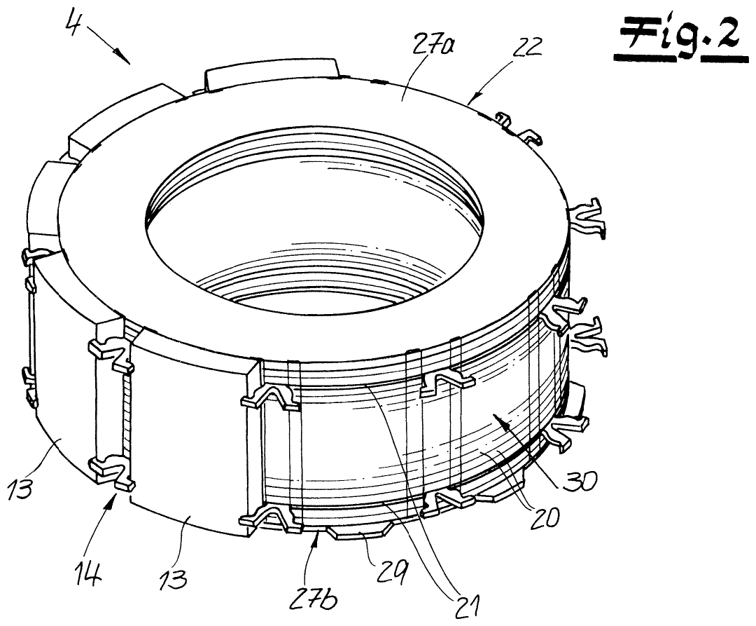

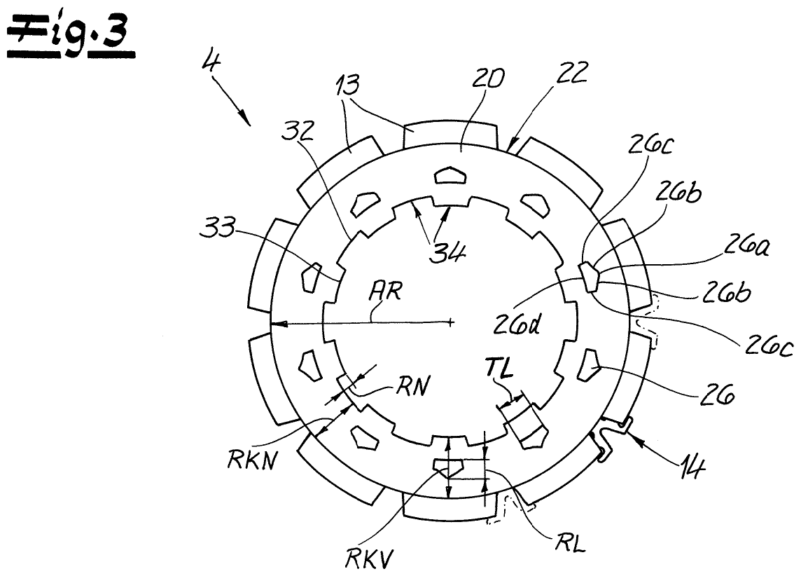

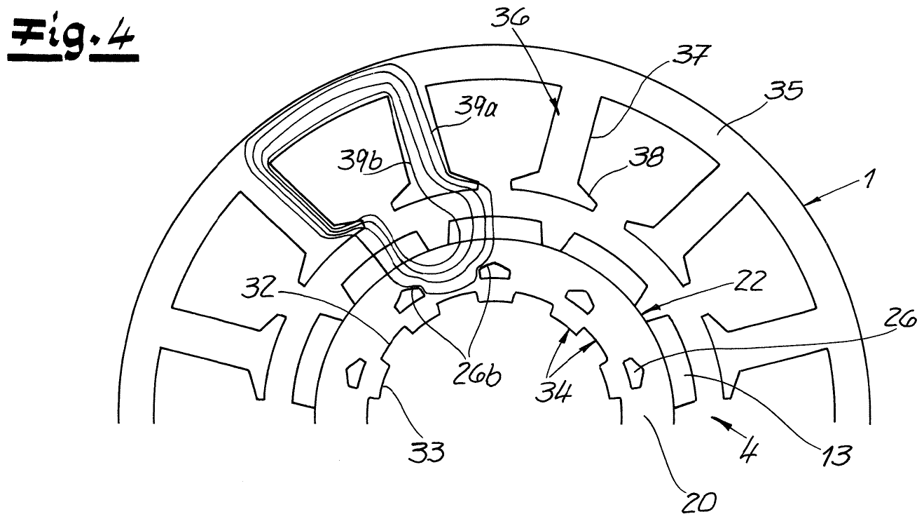

FIG. 2 shows a simplified view of the rotor block 4 or rotor core 22, as no grooves on a radial inner wall of the rotor core 22 are depicted here. However, these grooves 32 and projections 33 are visible on FIGS. 3 and 4. The grooves 32 and projections 33 especially preferably extend along the entire axial length of the rotor block 4 or the rotor core 22. It is advantageous that the upper cover lamella 27a, the lower cover lamella 27b, the holder lamellae 21 and/or the block lamellae 20 have the grooves 32 and the projections 33.

The magnets 13 are preferably arranged on a radially exterior side of the rotor core 22, see FIG. 2. To this end, the rotor block 4 comprises magnet holders 14, which hold the magnets 13 on the rotor core 22. Because the magnets 13 are held on the rotor core 22, the rotor block 4 as a whole is stable enough for later overmolding.

The rotor core 22 in this exemplary embodiment consists of 25 lamellae 20, 21, 27 stacked one on top of the other. The lamellae 20, 21, 27 are preferably electrical sheets. The electrical sheets are expediently provided with an insulating coating, thereby avoiding eddy currents, in particular in an axial direction. The lamellae 20, 21, 27 in this exemplary embodiment can be connected with each other to yield the rotor core 22 by means of stamped packaging or by means of baking varnish. In this exemplary embodiment, the rotor core 22 has exactly twenty two block lamellae 20 comprised of electrical sheets having the same shape.

The rotor block 4 in this exemplary embodiment comprises ten magnets 13 in all, which preferably are designed as permanent magnets. For better visualization, however, only five magnets 13 are shown on FIG. 2. It is preferred that the magnets 13 be arc-shaped in design on their radial interior side and/or on their radial exterior side with the rotor block viewed from above. It is advantageous that the rotor core 22 have ten magnetic spaces 30 on its radial exterior side in this exemplary embodiment, wherein each magnetic space 30 is allocated to a magnet 13. The magnet holders 14 or magnetic spaces 30 or magnets 13 are preferably equidistantly arranged relative to each other in a tangential direction.

In this exemplary embodiment, the lowermost lamella is designed as a lower cover lamella 27b. The lower cover lamella can have an electrical sheet or a plastic. The lower cover lamella 27b preferably comprises several, and in this exemplary embodiment ten, axial holders 29. Each axial holder 29 is expediently allocated to a magnetic space 30. The axial holders 29 are preferably designed as axial stops, so that the magnets 13 are downwardly securely held on the rotor core 22 in an axial direction. The rotor core may have an upper cover lamella 27a, which preferably is designed as a block lamella 20. It is possible for the lower cover lamella 27b to be located above the upper cover lamella 27a after pump assembly, so that the directional convention of the lamellae can deviate from the above directional convention of the pump.

According a preferred configuration, the rotor core 22 comprises two holder lamellae 21 or an upper holder lamella 21 and a lower holder lamella 21. The two holder lamellae 21 in this exemplary embodiment preferably have several magnet holders 14, preferably a respective number thereof corresponding to the number of magnets. It is preferred that the magnet holders 14 be an integral component of the holder lamella(e) 21. The magnet holders 14 or the holder lamella(e) 21 are preferably manufactured via punching. It is advantageous that the holder lamella 21 be arranged in an upper half or an upper third or an upper fourth of the rotor core 22. The lower holder lamella 21 is expediently arranged in a lower half or in a lower third or in a lower fourth of the rotor core 22.

FIG. 3 shows a simplified top view of the rotor block 4, because the upper cover lamella 27a was omitted to highlight an uppermost block lamella 20. FIG. 3 is also simplified relative to FIG. 2 in that the grooves on the radial outer wall of the rotor core 22 are missing. FIG. 3 is also simplified relative to FIG. 2 insofar as only one magnet holder 14 is shown.

According to the disclosure, the rotor core 22 has grooves 32 and projections 33 on its radial inner wall 34. The grooves 32 expediently alternate with the projections 33 in a tangential direction. In this exemplary embodiment, the tangential expansion of the grooves 32 corresponds to that of the projections 33. It is advantageous that the rotor core 22 be designed in such a way that the grooves 32 and the projections 33 complement each other to form the inner wall 34 of the rotor core 22. It is preferred that the inner wall 34 of the rotor core 22 consist exclusively of the grooves 32 and projections 33. It is possible that a tangential expansion of one of the grooves 32 correspond to a tangential expansion of an adjacent projection 33.

According to the disclosure, the rotor core 22 has holes 26. It is advantageous that the block lamellae and/or the holder lamellae have the holes 26. It is preferred that the upper cover lamella 27a and/or the lower cover lamella 27b have no holes. The holes 26 are preferably filled with air. This is advantageously achieved via the upper cover lamella 27a and the lower cover lamella 27b, which both have no holes, and cover the holes 26 of the other lamellae 20, 21. As a result, the holes 26 are not filled with plastic during an overmolding process.

It is preferred that the holes 26 extend in an axial direction over at least 50 or 60 or 70 or 80 or 90% of the axial expansion of the magnets 13. It is advantageous that the grooves 32 extend over at least 50 or 60 or 70 or 80 or 90 or 95% of the axial expansion of the magnets 13. It is very preferred that the upper cover lamella 27a and/or the lower cover lamella 27b have the grooves 32 and the projections 33 on their radial interior side.

It is preferred that the number of magnets 13 correspond to the number of holes 26, grooves 32 and/or projections 33. In a cross section of the rotor core 22, one of the holes 26 and/or one of the projections 33 is preferably allocated to at least one of the magnets 13, and preferably each of the magnets 13, in particular in a tangential direction. The at least one magnet 13 preferably overlaps in a tangential direction with the allocated hole 26 and/or with the allocated projection 33. In this exemplary embodiment, a hole 26 and a projection 33 respectively overlap each other in a tangential direction. It is preferable that the at least one magnet 13 and/or the hole 26 allocated to the magnet 13 and/or the projection 33 allocated to the magnet 13 be axially symmetrical in design relative to a common radius line.

It is advantageous that the holes 26 be offset in a tangential direction to the grooves 32. It is very preferred that the holes 26 and the grooves 32 alternate in a tangential direction. It is especially preferable that the holes 26 and the grooves 32 not overlap in a tangential direction. It is advantageous that free spaces in a tangential direction between the magnets 13 overlap with the grooves 32 in a tangential direction. It is very preferred that one of the free spaces between the magnets and a groove 32 overlapping with this free space in a tangential direction be axially symmetrical in design relative to a common radius.

In this exemplary embodiment, at least one hole 26 and preferably all holes 26 are polygonal, preferably at least triangular and especially preferably pentagonal in design. The at least one hole 26 preferably comprises a tip 26a, which advantageously faces radially outward. It is very preferred that the at least one hole 26 comprise a radial exterior side 26b. The tip 26a preferably represents the radially outermost point of the radial exterior side 26b. In this exemplary embodiment, the radial exterior side 26b is formed by two converging lines, which advantageously each extend in a tangential and in a radial direction. It is preferred that the at least one hole 26 comprise two tangential exterior sides 26c. It is advantageous that the at least one hole 26 comprise a radial interior side 26d. The radial interior side 26d expediently connects the two tangential exterior sides 26c.

The at least one hole 26 and preferably all holes 26 is/are preferably relatively flat in design. It is preferred that a tangential expansion TL of the at least one hole 26 be larger than a radial expansion RL of the hole 26. The rotor core 22 (K) has a radial (R) expansion RKV at the location of a projection 33 (V). It is very preferred that an RL/RKV ratio measure at most 0.70 or 0.65 or 0.50. In this exemplary embodiment, the RL/RKV ratio may measure about 0.40.

It is advantageous that the rotor core be relatively slender in design in a radial direction, in particular in the area of the grooves 32. The rotor core 22 (K) has a radial (R) expansion RKN at a location of a groove 32 (N). The rotor core 22 has an outer radius AR. The outer radius AR is preferably the arithmetically averaged value of all outer radii over a complete rotation. It is very preferred that an AR/RKN ratio measure at least 2.3 or 2.7 or 3.0. In this exemplary embodiment, this ratio may measure 3.5. A groove 32 (N) has a radial (R) expansion RN. The RN/RKN ratio preferably comes to at least 0.1 or 0.14 or 0.17 and, in the exemplary embodiment, roughly 0.21.

FIG. 4 shows a partial view of the rotor block 4 from FIG. 3, wherein the rotor block 4 is additionally also surrounded by a simplified stator 1 relative to FIG. 3. For the sake of simplicity, in particular stator windings as well as the partition wall 16 were omitted on FIG. 4. As a consequence, the stator 1 depicted here essentially corresponds to a cross section of a stator core or a top view of a lamella of the stator core. For the sake of simplicity, the magnet holders 1 as well as the grooves on the radial exterior side of the rotor core 22 were also omitted on FIG. 4.

The stator 1 or stator core has a stator ring 35 and a plurality of inwardly protruding poles 36. The poles 36 expediently each comprise a pole core 37 as well as a pole shoe 38. The undepicted stator winding is wound around the pole core 37 in particular in a tangential direction, and is held by the pole shoe 38 as well as by the stator ring 35 in a radial direction.

According to FIG. 4, magnetic field lines 39a, 39b form during pump operation. The magnetic field lines 39a, 39b form a closed circuit over a first pole core 37, the stator ring 35, a second pole core 37, a first magnet 13, the rotor core 22 and a second magnet 13. In the present case, the line 39a symbolizes an outer field line, while the line 39b represents an inner field line.

As evident on FIG. 4, the holes 26 preferably filled with air influence an expansion of the field lines 39a, 39b and in particular the outer field line 39a, so that the outer field line 39a runs along the radial exterior side 26b and along the tangential exterior side 26c of the holes 26. The outer field line 39a is also radially inwardly limited in particular by the groove 32.

As a result, the field lines 39a, 39b are concentrated on a smallest possible outer area inside of the rotor block 4 or rotor core 22, which yields a correspondingly low magnetic resistance. In particular, the holes 26 and the grooves 32 concentrate the magnetic field lines on a radially outer area of the rotor core 22, and additionally avoid stray fluxes. This is especially advantageous in particular for pumps with a partition wall and secondary flow, because the distance between the stator 1 and rotor block 4 is here larger, as a consequence of which the tendency toward field line divergence and stray fluxes is larger as well.

### REFERENCE LIST

| | |
|---|---|
| A | Axis of rotation |
| 1 | Stator |
| 2 | Rotor |
| 3 | Rotor body |
| 4 | Rotor block |
| 5 | Pivot bearing |
| 6 | Pump impeller |
| 7 | Shaft |
| 8 | Inlet |
| 9 | Outlet |
| 10 | Impeller chamber |
| 11 | Drive chamber |
| 12 | Return channels |
| 13 | Magnets |
| 14 | Magnet holder |
| 15 | Housing |
| 16 | Partition wall |
| 17 | Block housing |
| 18 | Circuit board |
| 19 | Blade of 6 |
| 20 | Block lamella |
| 21 | Holder lamella |
| 22 | Rotor core |
| 23 | Axle |
| 24 | Axle holder |
| 25 | Impeller cover of 2 |
| 26 | Hole |
| 27a | Upper cover lamella |
| 27b | Lower cover lamella |
| 28 | Collecting duct |
| 29 | Axial holder |
| 30 | Magnetic space |
| 31 | Impeller disk |
| 32 | Groove |
| 33 | Projection |
| 34 | Inner wall |
| 35 | Stator ring |
| 36 | Pole |
| 37 | Pole core |
| 38 | Pole shoe |
| 39a | Outer field line |
| 39b | Inner field line |
| AR | Outer radius |
| RN | Radial expansion of a groove |
| RL | Radial expansion of a hole |
| RKN | Radial expansion of the rotor core at the location of a groove |
| RKV | Radial expansion of the rotor core at the location of a projection |
| TL | Tangential expansion of a hole |

1. A pump for driving a fluid for use in a vehicle, for use in tempering a drive battery of an electric vehicle, the pump comprising:
a stator; and
a rotor, wherein the rotor has a rotor body and a rotor block, and is rotatably mounted around an axis of rotation, wherein the rotor block comprises a metallic rotor core and magnets,
wherein the rotor core comprises several holes in a cross-section,
wherein the rotor core has several grooves and several projections in a cross section on its radial inner wall.

2. The pump according to claim 1, wherein the pump is designed in such a way that the fluid flushes a block housing of the rotor body during pump operation.

3. The pump according to claim 1, wherein the holes are offset in a tangential direction to the grooves, wherein it is preferred that the holes and the grooves alternate in a tangential direction.

4. The pump according to claim 1, wherein the number of magnets corresponds to the number of holes, grooves and/or projections in a cross section of the rotor core.

5. The pump according to claim 1, wherein at least one of the holes and a projection allocated to the at least one hole in a tangential direction overlap in a tangential direction.

6. The pump according to claim 1, wherein a radial expansion RL of the holes and a radial expansion RKV of the rotor core have an RL/RKV ratio of at most 0.70 at a circumferential position of a projection.

7. The pump according to claim 1, wherein at least one of the grooves and/or at least one of the projections has a polygonal and/or a quadrangular shape.

8. The pump according to claim 1, wherein at least one of the holes has a polygonal and/or a pentagonal shape.

9. The pump according to claim 1, wherein at least one of the holes is filled with air.

10. The pump according to claim 1, wherein at least one of the grooves has a radial expansion RN, wherein the RN/RKN ratio amounts to at least 0.1.
